(19) United States
(12) Patent Application Publication
(10) Pub. No.: US 2016/0259745 A1
(43) Pub. Date: Sep. 8, 2016

(54) HIGH FREQUENCY APPARATUS AND METHOD FOR CONTROLLING HIGH FREQUENCY APPARATUS

(71) Applicant: Murata Manufacturing Co., Ltd., Kyoto (JP)

(72) Inventors: Atsushi ASAKA, Kyoto (JP); Hisao HAYAFUJI, Kyoto (JP)

(21) Appl. No.: 15/155,358

(22) Filed: May 16, 2016

Related U.S. Application Data
(63) Continuation of application No. PCT/JP2014/074812, filed on Sep. 19, 2014.

(30) Foreign Application Priority Data
Nov. 25, 2013 (JP) 2013-242467

(51) Int. Cl. G06F 13/364; G06F 13/42

(52) U.S. Cl. CPC G06F 13/364; G06F 13/4282

(57) ABSTRACT

A high frequency apparatus includes a master control device having a serial interface, and a plurality of slave devices having a serial interface. A control device for controlling the operations of the plurality of slave devices is provided. The serial interface of the master control device is connected to the control device and the serial interfaces of the slave devices. The slave devices have a control terminal for receiving a control signal for controlling whether or not each slave device is operable, and each of the control terminals is connected to the control device. The control device transmits the control signal to the control terminals of the slave devices in accordance with a data signal from the master control device.

### BACKGROUND

### Technical Field

The present disclosure relates to a high frequency apparatus that enables a desired device to operate by addressing and a method for controlling the high frequency apparatus.

In electronic equipment, for example, personal digital assistants installed with a high frequency apparatus typified by an RF (radio frequency) module, the use of serial communication as internal data communication has become mainstream owing to demands for faster data communication, lower power consumption, and the like. For example, a differential transmission system disclosed in Patent Document 1 uses the serial communication as the internal data communication.

To be more specific, for example, in cellular phones and the like, an RF module, which processes reception signals from an antenna and transmission signals to the antenna, includes a master control device (RFIC) and a plurality of slave devices (a switching circuit, a variable capacitance circuit, a power amplifier, and the like) connected to the master control device, so that the master control device controls the operations of the slave devices. The RF module supplies a high frequency signal to the antenna at the time of transmission, and receives a high frequency signal from the antenna and processes the signal at the time of reception.

Patent Document 1: Japanese Unexamined Patent Application Publication No. 2009-141561

### BRIEF SUMMARY

However, in the differential transmission system (serial control system) disclosed in the Patent Document 1, the number of addresses of the slave devices to be controlled is sometimes limited by specifications. Thus, there is a problem that the number of the slave devices whose operations are controllable is limited. The provision of a plurality of serial interfaces can solve this problem, as a matter of course, but is likely to interfere with miniaturization of the electronic equipment, that is, cause an increase in a chip area, and the like.

Also, in a case where there is a plurality of slave devices having the same address and the operations of the slave devices are controlled using a single serial interface, the plurality of slave devices operate with a single signal at the same time. Accordingly, the plurality of slave devices can unintendedly operate at the same time, thus reducing the degree of flexibility in circuit design.

Under the circumstances described above, the present disclosure aims to provide a high frequency apparatus that enables desired operation control even if there are a plurality of slave devices having the same address, without necessarily increasing the number of serial interfaces, and a method for controlling the high frequency apparatus.

A high frequency apparatus according to the present disclosure includes a master control device having a serial interface, and a plurality of slave devices having a serial interface. A control device for controlling the operations of the plurality of slave devices is provided. The serial interface of the master control device is connected to the control device and the serial interfaces of the slave devices. The slave devices have a control terminal for receiving a control signal for controlling whether or not each slave device is operable, and each of the control terminals is connected to the control device. The control device transmits the control signal to the control terminals of the slave devices in accordance with a data signal from the master control device.

According to the above configuration, the serial interface of the master control device is connected to the control device and the serial interfaces of the plurality of slave devices, and the slave devices have the control terminal for receiving the control signal for controlling whether or not each slave device is operable, and each of the control terminals is connected to the control device. The control device transmits the control signal to the control terminals of the slave devices in accordance with the data signal from the master control device. Thus, the control device can control whether or not the slave devices are in an operable state. In order to control the operable state of the slave devices, all the master control device would have to do is to transmit information about addresses of the slave devices and information about whether or not to put the slave devices into the operable state only to the control device. Therefore, it is possible to operate the desired slave device without necessarily making the master control device have complicated circuit design, thus allowing miniaturization of the high frequency apparatus as a whole.

In the high frequency apparatus according to the present disclosure, the control device and the plurality of slave devices can be mounted on the same circuit board.

According to the above configuration, since the control device and the plurality of slave devices are mounted on the same circuit board, the entire apparatus can be more miniaturized, and the master control device regards the control device and the plurality of slave devices as one component having a common device address, thus control of the operations of the slave devices can be made with ease.

In the high frequency apparatus according to the present disclosure, the slave device can be put into the operable state upon receiving the control signal at an ON level.

According to the above configuration, since the slave device is put into the operable state upon receiving the control signal at the ON level, it is possible to control whether or not the slave devices are in the operable state in accordance with the data signal from the master control device.

In the high frequency apparatus according to the present disclosure, the control device can have a serial/parallel conversion function to convert between a serial signal and parallel signals.

According to the above configuration, since each of the control terminals of the slave devices is connected to a control terminal of the control device having the serial/parallel conversion function, it is possible to control whether or not each slave device is in the operable state by the parallel signal. Thus, it becomes possible to control the operations of both of the slave devices having the serial interface and slave devices having a parallel interface.

The high frequency apparatus according to the present disclosure can include a plurality of other slave devices different from the abovementioned slave devices, the other slave devices can have a parallel interface, and the parallel interface can be connected to the control terminal of the control device having the serial/parallel conversion function.

According to the above configuration, even if the plurality of other slave devices different from the slave devices are provided, the parallel interfaces of the other slave devices are connected to the control terminal of the control device having the serial/parallel conversion function, and therefore the operations of the other slave devices can be controlled by the parallel signals.

In the high frequency apparatus according to the present disclosure, the master control device and the control device can be integrated into one unit.

According to the above configuration, integrating the master control device and the control device into one unit brings about the more miniaturized high frequency apparatus.

In the high frequency apparatus according to the present disclosure, the slave device can be a high frequency switch or a power amplifier.

According to the above configuration, since the slave device is the high frequency switch or the power amplifier, the operation of the high frequency switch or the power amplifier can be controlled in accordance with the data signal from the master control device.

Next, a high frequency apparatus according to the present disclosure includes a master control device having a serial interface, and a plurality of slave devices having a serial interface. A control device for controlling the operations of the plurality of slave devices is provided. The plurality of slave devices forms a group. The serial interface of the master control device is connected to the control device and the serial interfaces of the plurality of slave devices. The slave devices have a control terminal on a group basis to receive a control signal for controlling whether or not each slave device is operable, and each of the control terminals is connected to the control device. The control device transmits the control signal to the control terminals on a group basis in accordance with a data signal from the master control device.

According to the above configuration, the plurality of slave devices form the group, and the serial interface of the master control device is connected to the control device and the serial interfaces of the slave devices, and the slave devices have the control terminal on a group basis to receive the control signal for controlling whether or not each slave device is operable, and each of the control terminals is connected to the control device. The control device transmits the control signal to the control terminals on a group basis in accordance with the data signal from the master control device. Thus, the control device can control whether or not the slave devices are in the operable state on a group basis. In order to control the operable state of the slave devices, all the master control device would have to do is to transmit information about addresses of the slave devices and information about whether or not to put the slave devices into the operable state only to the control device. Therefore, it is possible to operate the group of the desired slave devices without necessarily making the master control device have complicated circuit design, thus allowing miniaturization of the high frequency apparatus as a whole.

Next, in a method for controlling a high frequency apparatus according to the present disclosure, the high frequency apparatus includes a master control device, a plurality of slave devices having a serial interface, and a control device for controlling an operable or inoperable state of the slave devices. The method for controlling the high frequency apparatus includes a first step in which the master control device transmits a data signal to the control device; a second step in which the control device transmits a control signal for controlling the operable or inoperable state of the plurality of slave devices to the plurality of slave devices based on the received data signal; a third step in which the plurality of slave devices are put into the operable or inoperable state in accordance with the control signal; and a fourth step in which the master control device transmits the data signal to the plurality of slave devices.

According to the above configuration, the master control device transmits the data signal to the control device, and the control device transmits the control signal for controlling the operable or inoperable state of the plurality of slave devices to the plurality of slave devices based on the received data signal. The plurality of slave devices are put into the operable or inoperable state in accordance with the control signal, and the master control device transmits the data signal to the plurality of slave devices. Thus, the control device can control whether or not the slave devices are in the operable state. In order to control the operable state of the slave devices, all the master control device would have to do is to transmit information about addresses of the slave devices and information about whether or not to put the slave devices into the operable state only to the control device. Therefore, it is possible to operate the desired slave device without necessarily making the master control device have complicated circuit design, thus allowing miniaturization of the high frequency apparatus as a whole.

In the method for controlling the high frequency apparatus according to the present disclosure, the slave device can be put into the operable state upon receiving the control signal at an enable level.

According to the above configuration, since the slave device is put into the operable state upon receiving the control signal at the enable level, it is possible to control whether or not the slave devices are in the operable state in accordance with the data signal from the master control device.

In the method for controlling the high frequency apparatus according to the present disclosure, the control device can convert between a serial signal and parallel signals.

According to the above configuration, since the control terminals of the slave devices are connected to a control terminal of the control device having a serial/parallel conversion function, it is possible to control whether or not each slave device is in the operable state by the parallel signal. Thus, it becomes possible to control the operations of both of the slave devices having the serial interface and slave devices having a parallel interface.

According to the configurations described above, the serial interface of the master control device is connected to the control device and the serial interfaces of the plurality of slave devices. The slave devices have the control terminal for receiving the control signal for controlling whether or not each slave device is operable, and each of the control terminals is connected to the control device. The control device transmits the control signal to the control terminals of the slave devices in accordance with the data signal from the master control device. Thus, the control device can control whether or not the slave devices are in the operable state. Accordingly, in order to control the operable state of the slave devices, all the master control device would have to do is to transmit information about addresses of the slave devices and information about whether or not to put the slave devices into the operable state only to the control device. Therefore, it is possible to operate the desired slave device without necessarily making the master control device have complicated circuit design, thus allowing miniaturization of the high frequency apparatus as a whole.

### BRIEF DESCRIPTION OF THE SEVERAL VIEWS OF THE DRAWINGS

FIG. 1 is a block diagram showing the configuration of a conventional high frequency apparatus.

FIG. 2 is a block diagram showing the configuration of a high frequency apparatus according to a first embodiment of the present disclosure.

FIG. 3 is a schematic diagram showing the configuration of a slave device in the high frequency apparatus according to the first embodiment of the present disclosure.

FIG. 4 is an explanatory view of a method for controlling the operations of the slave devices in the high frequency apparatus according to the first embodiment of the present disclosure.

FIG. 5 is a schematic diagram showing the configuration of the high frequency apparatus, including wire connection, according to the first embodiment of the present disclosure.

FIG. 6 is a schematic diagram showing another configuration of the high frequency apparatus, including wire connection, according to the first embodiment of the present disclosure.

FIG. 7 is a schematic diagram showing the configuration of a high frequency apparatus, including wire connection, according to a second embodiment of the present disclosure.

FIG. 8 is a schematic diagram showing another configuration of the high frequency apparatus, including wire connection, according to the second embodiment of the present disclosure.

FIG. 9 is a schematic diagram showing the configuration of a high frequency apparatus, including wire connection, according to a third embodiment of the present disclosure.

### DETAILED DESCRIPTION

Embodiments of the present disclosure will be described below in detail with reference to the drawings.

### First Embodiment

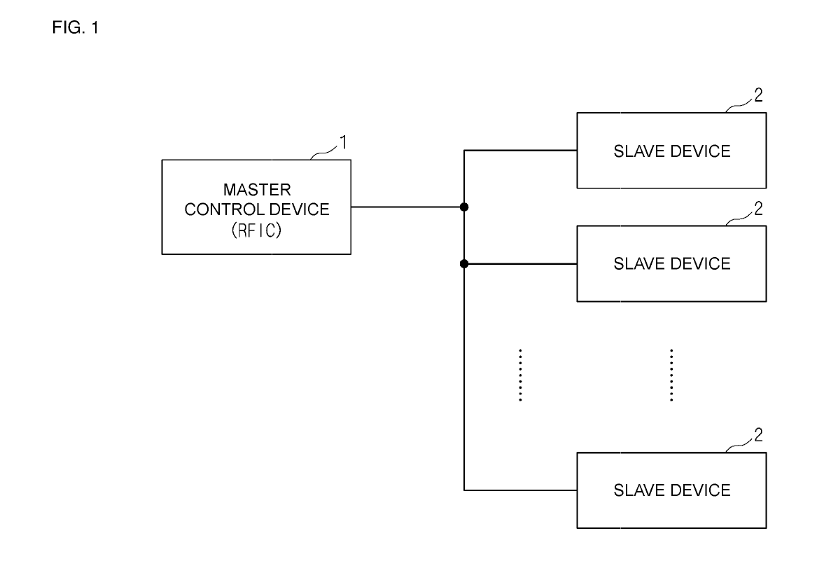

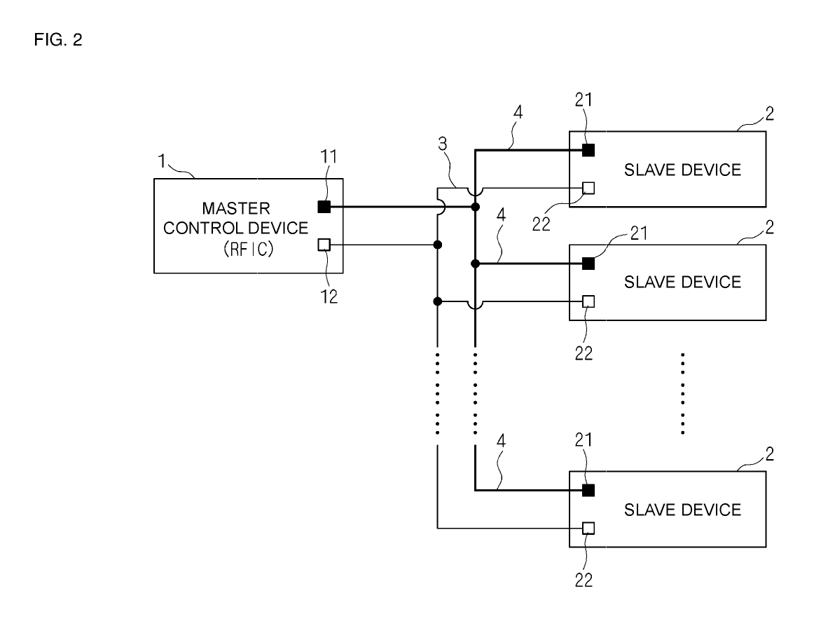

FIG. 1 is a block diagram showing the configuration of a conventional high frequency apparatus, and FIG. 2 is a block diagram showing the configuration of a high frequency apparatus according to a first embodiment of the present disclosure. As shown in FIGS. 1 and 2, the high frequency apparatuses are each constituted of a master control device (RFIC) 1 and a plurality of slave devices 2 the operations of which are controlled based on a control signal from the master control device 1. In the first embodiment, the slave device 2 is, for example, a high frequency switch, a power amplifier, or the like.

The conventional high frequency apparatus performs serial communication, while specifying a slave address to which a data signal is to be transmitted using a device address designated in the data signal.

However, in the serial communication, there are cases where the number of bits assigned to device addresses is limited by specifications. For example, in the case of four device address bits, the number of designable device addresses is 16.

Thus, the master control device 1 cannot be connected to more than 16 slave devices 2 through control lines of one system. Also, when there is a plurality of slave devices 2 having the same address in the one system, a malfunction may occur.

Thus, in the first embodiment, as shown in FIG. 2, a communication line (hereinafter called data bus) 3 for data communication and a communication line (hereinafter called enable control line) 4 for a control signal to control an operable state (hereinafter called enable state) of the slave devices 2 are provided separately. The master control device 1 is provided with not only a serial interface 12 to which the data bus 3 is connected, but also an control terminal 11 to which the enable control line 4 is connected. In a like manner, each slave device 2 is provided with not only a serial interface 22 to which the data bus 3 is connected, but also a control terminal 21 to which the enable control line 4 is connected. It is noted that in the first embodiment, the term “enable state” means a state in which the slave device 2 can receive a data signal transmitted from the master control device 1 through the data bus 3. On the contrary, the term “disable state” means a state in which the slave device 2 cannot receive a data signal transmitted from the master control device 1 through the data bus 3.

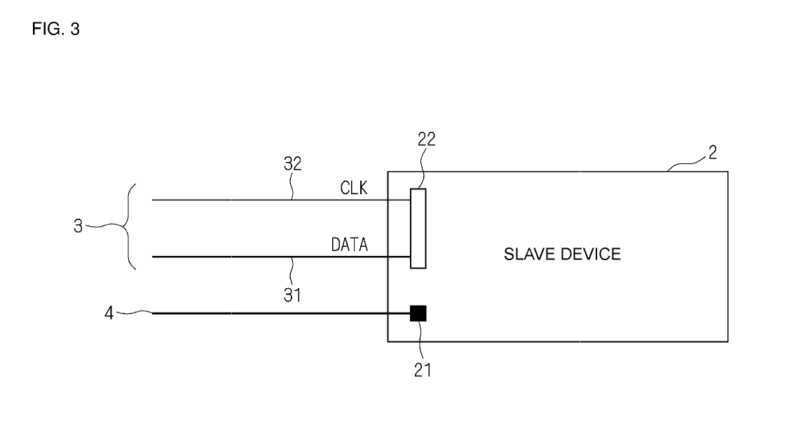

In actuality, the data bus 3 is constituted of a data signal line and a clock signal line. FIG. 3 is a schematic diagram showing the configuration of the slave device 2 in the high frequency apparatus according to the first embodiment of the present disclosure.

As shown in FIG. 3, the data bus 3 is constituted of a data signal line 31 and a clock signal line 32, and the slave device 2 receives data (signal) including a device address designated by the master control device 1 through the data signal line 31 by the serial interface 22. The data signal line 31 and the clock signal line 32 are connected to the serial interface 22, and the enable control line 4 is connected to the separate control terminal 21. The control terminal 21 receives, for example, a High/Low signal as a control signal. The High signal puts the slave device 2 into the enable state, while the Low signal puts the slave device 2 into the disable state.

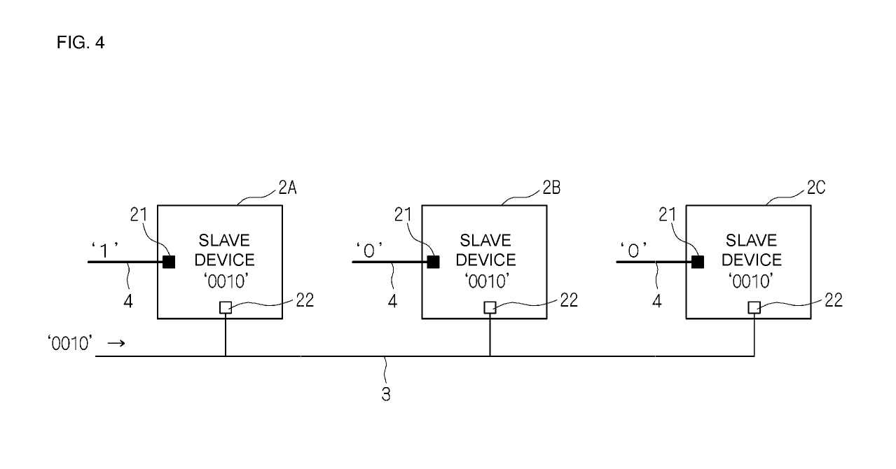

FIG. 4 is an explanatory view of a method for controlling the operations of the slave devices 2 in the high frequency apparatus according to the first embodiment of the present disclosure. FIG. 4 takes a case where the plurality of slave devices 2 having the same four-bit device address “0010” are connected to the single master control device 1, as an example.

As shown in FIG. 4, the plurality of slave devices 2A, 2B, and 2C having the same device address are connected to the signal master control device 1. The enable control line 4 is connected to the control terminals 21 of the slave devices 2A, 2B, and 2C. For example, to operate the slave device 2A, the master control device 1 transmits a High signal only to the slave device 2A and Low signals to the slave devices 2B and 2C from the control terminal 11 through the enable control line 4. Thus, an enable bit of the slave device 2A becomes “1” and thus the slave device 2A is put into the enable state, which enables data transmission and reception. On the other hand, enable bits of the slave devices 2B and 2C become “0” and thus the slave devices 2B and 2C are put into the disable state, which disables data transmission and reception.

When only the slave device 2A is in the enable state, the master control device 1 transmits a data signal including the address “0010” that indicates the slave device 2 to be controlled to all of the slave devices 2A, 2B, and 2C through the data bus 3. Since the enable bits of the slave devices 2B and 2C are “0”, the slave devices 2B and 2C cannot receive the data signal. Thus, even if the device address included in the data signal coincides with the address of the slave devices 2B and 2C, the slave devices 2B and 2C do not operate. It is noted that a predetermined interval is provided between the timing of transmitting a control signal through the enable control line 4 and the timing of transmitting a data signal through the data bus 3.

Since the enable bit of the slave device 2A is “1”, the slave device 2A determines whether or not the received device address coincides with the address of the slave device 2A. If the addresses coincide, the slave device 2A operates.

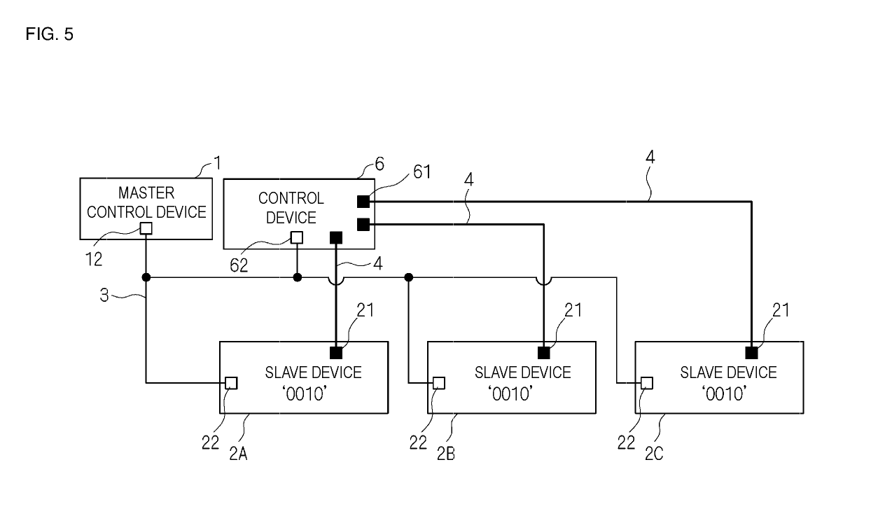

In actuality, the master control device 1 is connected to a control device, and the control device controls whether or not the slave devices 2 are operable. FIG. 5 is a schematic diagram showing the configuration of the high frequency apparatus, including wire connection, according to the first embodiment of the present disclosure.

As shown in FIG. 5, the master control device 1 is connected (serially connected) to the serial interfaces 22 of the slave devices 2A, 2B, and 2C through the data bus 3 connected to the serial interface 12. The master control device 1 is also connected to a serial interface 62 of a control device 6 through the data bus 3. On the other hand, the control device 6 has a plurality of control terminals 61 connected to the slave devices 2A, 2B, and 2C through the plurality of enable control lines 4, respectively.

The enable control lines 4 are each connected to the control terminal 21 of the slave device 2A, 2B, or 2C by, for example, parallel connection, and in an example of FIG. 5, the control device 6 transmits a High signal only to the slave device 2A and Low signals to the slave devices 2B and 2C, as control signals. Thus, the enable bit of the slave device 2A becomes “1” and thus the slave device 2A is put into the enable state, which enables data transmission and reception. On the other hand, the enable bits of the slave devices 2B and 2C become “0” and thus the slave devices 2B and 2C are put into the disable state, which disables data transmission and reception. Also, the control device 6 has a serial/parallel conversion function to convert between a serial signal and parallel signals. Since the control device 6 converts a data signal from the master control device from a serial format into a parallel format, each slave device 2 can receive a control signal through the enable control line 4.

To be more specific, the master control device 1 first transmits a data signal that includes a device address indicating the control device 6 to be controlled through the data bus 3 to the control device 6 and all of the slave devices 2A, 2B, and 2C. The control device 6 that has received the data signal subjects the data signal to the serial/parallel conversion, and transmits the converted data signals to the slave devices 2A, 2B, and 2C through the enable control lines 4. In the example of FIG. 5, a High signal is transmitted to the slave device 2A, and Low signals are transmitted to the slave devices 2B and 2C, as described above.

It is noted that in a case where the slave devices 2A, 2B, and 2C are in the disable state at the time of transmitting a data signal from the master control device 1, the slave devices 2A, 2B, and 2C cannot receive the data signal. Even if the slave devices 2A, 2B, and 2C are in the enable state, the slave devices 2A, 2B, and 2C do not operate at this point in time because the address of the control device 6 is different from the device address of the slave devices 2A, 2B, and 2C.

The slave device 2A that has received the High signal has the enable bit of “1” and is put into the enable state. The slave devices 2B and 2C that have received the Low signal have the enable bit of “0” and are put into the disable state.

Next, in a state of setting the enable bits of the slave devices 2A, 2B, and 2C, the master control device 1 transmits a data signal that includes the address “0010” indicating the slave device 2 to be controlled to all of the slave devices 2A, 2B, and 2C through the data bus 3. The slave devices 2B and 2C cannot receive the data signal, because of the enable bit of “0”. Thus, even if the address included in the data signal corresponds with the device address of the slave devices 2B and 2C, the slave devices 2B and 2C do not operate.

Since the slave device 2A has the enable bit of “1”, the slave device 2A determines whether or not the address of the received data signal corresponds with the device address of the slave device 2A. In the example of FIG. 5, the addresses coincide, and therefore the slave device 2A operates.

According to the first embodiment, as described above, since the control device 6 can control whether or not the slave devices 2 are in the operable state, it is possible to operate only the slave device 2 that is in the operable state, even if the high frequency apparatus includes the slave devices 2 having the same device address. Thus, it is possible to operate the desired slave device 2 without necessarily making the master control device 1 have complicated circuit design, allowing miniaturization of the high frequency apparatus as a whole.

It is noted that in a case where the control device 6 and the slave devices 2 have the same device address, when the slave devices 2A, 2B, and 2C are in the disable state at the time of transmitting a data signal from the master control device 1, the slave devices 2A, 2B, and 2C cannot receive the data signal.

In a case where the control device 6 and the slave devices 2 have the same device address, even if the slave devices 2A, 2B, and 2C are in the enable state at the time of transmitting a data signal from the master control device 1, the data signal is not in a data format to control the operations of the slave devices 2A, 2B, and 2C, so that the slave devices 2A, 2B, and 2C do not operate though receiving the data signal. Accordingly, in a case where the control device 6 and the slave devices 2 are configured at the same address into a single high frequency apparatus without necessarily having the master control device 1, the separately provided master control device 1 regards the high frequency apparatus as one component having the common device address, thus serving easy operation control of the slave devices 2.

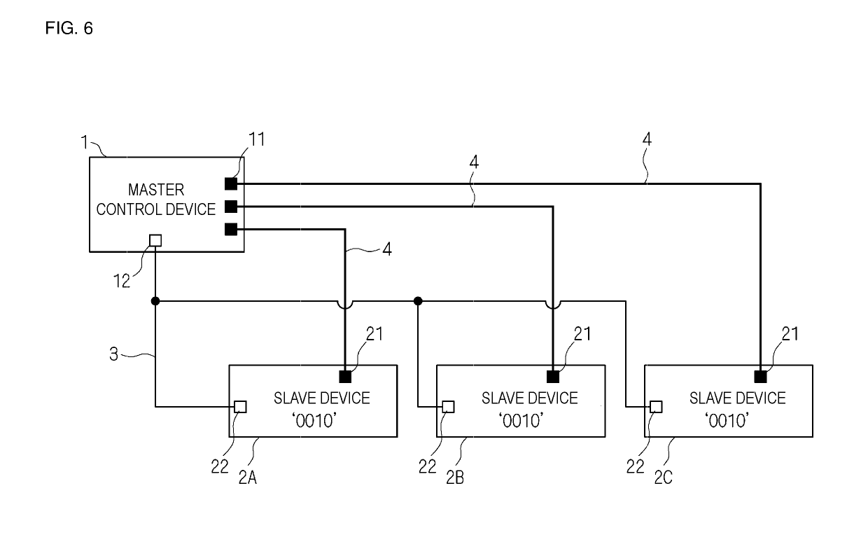

It is noted that the control device 6 may be integrated into the master control device 1. FIG. 6 is a schematic diagram showing another configuration of the high frequency apparatus, including wire connection, according to the first embodiment of the present disclosure.

As shown in FIG. 6, the master control device 1 has the function of the control device 6, that is, the function of transmitting a control signal to control whether or not the slave devices 2 are in the operable state by parallel communication. Thus, in addition to the connection of the data bus 3 to the serial interface 12 of the master control device 1, the enable control lines 4 for the parallel communication are connected to the control terminals 11. The enable control line 4 is connected to the control terminal 21 of each slave device 2, and the master control device 1 controls whether or not the slave devices 2 are in the operable state through the enable control lines 4, and then transmits a data signal to the slave device 2 to be controlled through the data bus 3, so that the same effect can be expected.

As described above, by integrating all control functions into the master control device 1, it is possible to provide the more miniaturized high frequency apparatus.

### Second Embodiment

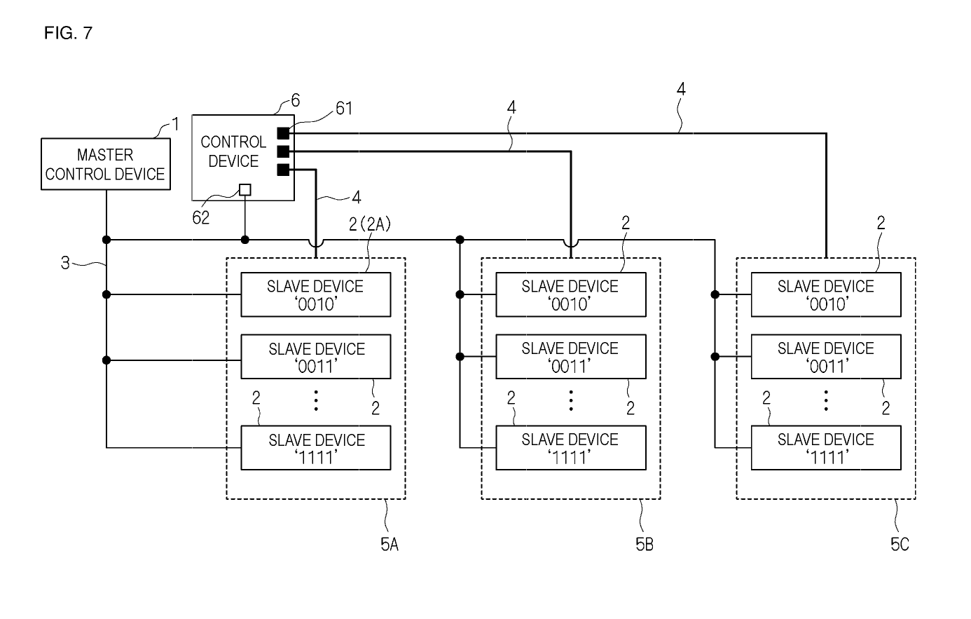

A high frequency apparatus according to a second embodiment has the same fundamental configuration as the high frequency apparatus according to the first embodiment, so that detailed description will be omitted using the same reference signs. The second embodiment differs from the first embodiment in terms that the plurality of slave devices 2 is grouped and the enable control lines 4 connect the slave devices 2 on a group basis. FIG. 7 is a schematic diagram showing the configuration of the high frequency apparatus, including wire connection, according to the second embodiment of the present disclosure.

As shown in FIG. 7, the master control device 1 is connected (serially connected) to the slave devices 2 belonging to each group and the control device 6 through the data bus 3. On the other hand, the control device 6 has the plurality of control terminals 61 that are connected to groups 5A, 5B, and 5C through the plurality of enable control lines 4.

The control terminals 21 of the slave devices 2 belonging to each group 5A, 5B, or 5C are connected to a single control terminal 61 by parallel connection on a group basis through the enable control lines 4, but FIG. 7 shows as if the enable control line 4 is connected to each group 5A, 5B, or 5C, for the sake of simplicity of the drawing. The serial interfaces 12 and 22 are also omitted.

While the slave devices 2 have different device addresses from one another within each group 5A, 5B, or 5C, the slave devices 2 having the same device address may be used in different groups. Thus, even if the number of the device addresses that are serially connected to the master control device 1 is limited to 16, more than 16 slave devices 2 can be connected.

In an example of FIG. 7, the control device 6 transmits a High signal to the plurality of slave devices 2 belonging to the group 5A, and Low signals to the plurality of slave devices 2 belonging to the groups 5B and 5C, as control signals. Thus, all of the slave devices 2 belonging to the group 5A have an enable bit of “1” and are put into an enable state (operable state), which enables data transmission and reception. On the other hand, all of the slave devices 2 belonging to the other groups 5B and 5C have an enable bit of “0” and are put into a disable state, which disables data transmission and reception.

To be more specific, the master control device 1 first transmits a data signal that includes a device address indicating the control device 6 to be controlled through the data bus 3 to the control device 6 and the slave devices 2 belonging to all of the groups 5A, 5B, and 5C. The control device 6 that has received the data signal including the device address subjects the data signal to a serial/parallel conversion, and transmits the converted data signals to all of the slave devices 2 belonging to the groups 5A, 5B, and 5C as the control signals. In the example of FIG. 7, as described above, the High signal is transmitted to the group 5A, and the Low signals are transmitted to the groups 5B and 5C.

It is noted that when the slave devices 2 are in the disable state at the time of transmitting the data signal from the master control device 1, the slave devices 2 cannot receive the data signal. Even if the slave devices 2 are in the enable state, the slave devices 2 do not operate at this point in time because the address of the control device 6 is different from those of the slave devices 2.

Upon receiving the High signal, the slave devices 2 belonging to the group 5A have the enable bit of “1” and are put into the enable state (operable state). Upon receiving the Low signals, the slave devices 2 belonging to the groups 5B and 5C have the enable bit of “0” and are put into the disable state.

In a state where only the slave devices 2 belonging to the group 5A are in the enable state, the master control device 1 transmits a data signal that includes an address “0010” indicating the slave device 2 to be controlled through the data bus 3 again. The slave devices 2 belonging to the groups 5B and 5C have the enable bit of “0” and therefore cannot receive the data signal. Thus, even if the slave device 2 having the coincident address is present, no slave device 2 operates in the groups 5B and 5C.

On the other hand, each of the slave devices 2 belonging to the group 5A has the enable bit of “1”, and therefore determines whether or not the address of each slave device 2 coincides with the received address. In the example of FIG. 7, the slave device 2A has the coincident address, so that only the slave device 2A operates.

According to the second embodiment as described above, since whether or not the slave devices 2 are operable is controlled on a group basis, even if the number of addresses indicated by serial control is limited, it is possible to connect the slave devices 2 the number of which is beyond the limitation and operate the desired slave device 2.

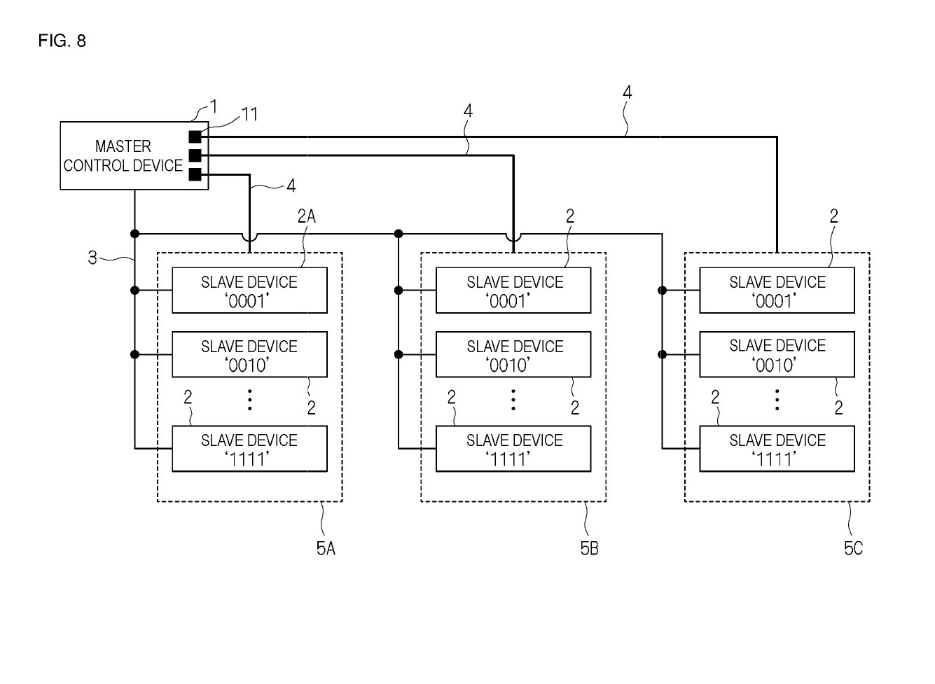

It is noted that the control device 6 may be integrated into the master control device 1. FIG. 8 is a schematic diagram showing another configuration of the high frequency apparatus, including wire connection, according to the second embodiment of the present disclosure.

As shown in FIG. 8, the master control device 1 has the function of the control device 6, that is, the function of transmitting a control signal to control whether or not the slave devices 2 are in the operable state by parallel communication. Thus, in addition to the connection of the data bus 3 to the serial interface 12 of the master control device 1, the enable control lines 4 for the parallel communication are connected to the control terminals 11. The enable control line 4 is connected to the control terminal 21 of each slave device 2, and the master control device 1 controls whether or not the slave devices 2 are in the operable state through the control terminals 11 and the enable control lines 4, and then transmits a data signal that includes an address of the slave device 2 to be controlled through the data bus 3, so that the same effect can be expected.

As described above, by integrating all control functions into the master control device 1, it is possible to provide the more miniaturized high frequency apparatus.

### Third Embodiment

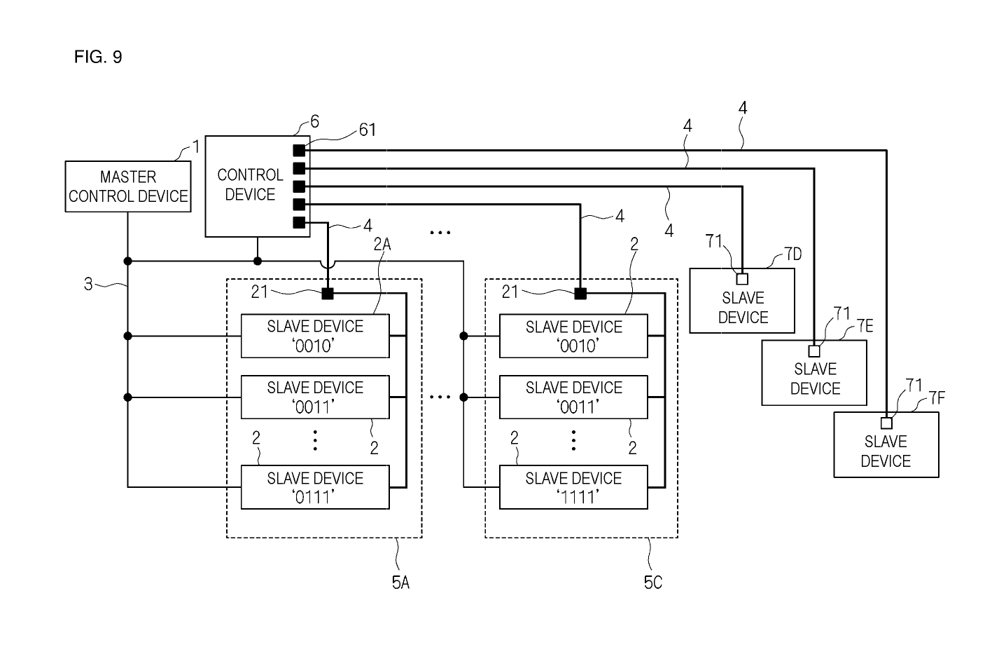

A high frequency apparatus according to a third embodiment has the same fundamental configuration as the high frequency apparatuses according to the first and second embodiments, so that detailed description will be omitted using the same reference signs. The third embodiment differs from the first and second embodiments in terms of the provision of slave devices 7D, 7E, and 7F the operations of which are controlled only by parallel communication from the control device 6. FIG. 9 is a schematic diagram showing the configuration of the high frequency apparatus, including wire connection, according to the third embodiment of the present disclosure.

As shown in FIG. 9, the master control device 1 is connected to the slave devices 2 belonging to each of the groups 5A to 5C and the control device 6 through the data bus 3 (serial communication). On the other hand, the control device 6 has the plurality of control terminals 61 that are connected to the groups 5A, 5B, and 5C through the plurality of enable control lines 4. The slave devices (the other slave devices) 7D, 7E, and 7F that do not belong to any group are also connected to the control device 6 in parallel through the plurality of enable control lines 4 and control terminals 61.

The enable control lines 4 are connected to the control terminals 21 of the slave devices 2 belonging to each of the groups 5A to 5C by, for example, parallel connection, but for the sake of simplicity of the drawing, FIG. 9 omits the group 5B and shows as if the enable control lines 4 are connected to the groups 5A to 5C. The serial interfaces 12 and 22 are also omitted.

While the slave devices 2 have different device addresses from one another in each of the groups 5A to 5C, the slave devices 2 having the same device address may be used in different groups. Thus, even if the number of the device addresses that are serially connectable to the master control device 1 is limited to 16, more than 16 slave devices 2 can be connected.

The enable control lines 4 are connected to parallel interfaces 71 of the other slave devices 7D, 7E, and 7F, to transmit and receive data signals that are subjected to a serial/parallel conversion by the control device 6 therethrough. The operations of the slave devices 7D, 7E, and 7F are controlled through the enable control lines 4.

Since the slave devices 2 belonging to the groups are controlled in the same manner as those of the second embodiment, detailed description will be omitted using the same reference signs.

According to the third embodiment of the present disclosure, as described above, even if the other slave devices 7D, 7E, and 7F that do not belong to any group are provided, the operations of the slave devices 7D, 7E, and 7F can be controlled by parallel communication.

The above-described embodiments are intended to be modified within the scope of the present disclosure, as a matter of course. For example, needless to say, the functions of the control device 6 may be integrated into the master control device 1 in the third embodiment.

### REFERENCE SIGNS LIST

1 MASTER CONTROL DEVICE
2, 2A, 2B, 2C SLAVE DEVICE
3 DATA BUS
4 ENABLE CONTROL LINE
5A, 5B, 5C GROUP (MODULE)
7D, 7E, 7F SLAVE DEVICE (ANOTHER SLAVE DEVICE)
11, 21, 61 CONTROL TERMINAL
12, 22, 62 SERIAL INTERFACE
71 PARALLEL INTERFACE

1. A high frequency apparatus comprising:
a master control device having a serial interface;
a plurality of slave devices, each slave device having a serial interface and a control terminal for receiving a control signal for controlling whether the slave device is operable to receive data signals from the master control device; and
a control device for controlling the operations of the plurality of slave devices, wherein
the serial interface of the master control device is connected to the control device and to the serial interfaces of the slave devices,
the control device transmits control signals to the control terminals of the slave devices in accordance with a data signal from the master control device.

2. The high frequency apparatus according to claim 1, wherein the control device and the plurality of slave devices are mounted on the same circuit board.

3. The high frequency apparatus according to claim 1, wherein the slave device is operable to receive data signals from the master control device upon receiving a control signal at a HIGH level.

4. The high frequency apparatus according to claim 1, wherein the control device has a serial/parallel conversion function to convert between a serial signal and parallel signals.

5. The high frequency apparatus according to claim 4, further comprising a plurality of other slave devices, each having a parallel interface, wherein
the parallel interfaces are connected to control terminals of the control device having the serial/parallel conversion function.

6. The high frequency apparatus according to claim 1, wherein the master control device and the control device are integrated.

7. The high frequency apparatus according to claim 1, wherein the slave device is a high frequency switch or a power amplifier.

8. The high frequency apparatus according to claim 1, wherein the plurality of slave devices have a common address.

9. The high frequency apparatus according to claim 1, the plurality of slave devices forming at least one group, wherein
the control device transmits a common control signal to the control terminals of the slave devices on a group basis in accordance with the data signal from the master control device, and
the common control signal controls whether each slave device of a group is operable to receive data signals from the master control device.

10. The high frequency apparatus according to claim 9, the plurality of slave devices forming at least two groups, wherein
each slave device in a group of the at least two groups has a unique address, and
at least two slave devices in different groups share a common address.

11. A method for controlling a high frequency apparatus including:
a master control device;
a plurality of slave devices, each slave device having a serial interface; and
a control device for controlling whether the slave devices are operable to receive data signals from the master control device,
the method for controlling the high frequency apparatus comprising:
transmitting a data signal from the master control device to the control device;
transmitting control signals from the control device to the plurality of slave devices based on the data signal, the control signals controlling whether the slave devices are operable to receive data signals from the master control device;
placing the plurality of slave devices into an operable or inoperable state in accordance with the control signal; and
transmitting data signals from the master control device to the plurality of slave devices.

12. The method for controlling the high frequency apparatus according to claim 11, wherein the control device and the plurality of slave devices are mounted on the same circuit board.

13. The method for controlling the high frequency apparatus according to claim 11, wherein the slave device is placed into the operable state upon receiving a control signal at a HIGH level.

14. The method for controlling the high frequency apparatus according to claim 11, wherein the control device converts between a serial signal and parallel signals.

15. The method for controlling the high frequency apparatus according to claim 14, wherein the high frequency apparatus further includes a plurality of other slave devices, each having a parallel interface, the method further comprising:
converting, at the control device, the data signal transmitted from the master control device to the control device to parallel signals; and
transmitting the parallel signals from the control device to the plurality of other slave devices.

16. The method for controlling the high frequency apparatus according to claim 11, wherein the master control device and the control device are integrated.

17. The method for controlling the high frequency apparatus according to claim 11, wherein the slave device is a high frequency switch or a power amplifier.

18. The method for controlling the high frequency apparatus according to claim 11, wherein the plurality of slave devices have a common address.

19. The method for controlling the high frequency apparatus according to claim 11, the plurality of slave devices forming at least one group, wherein transmitting control signals from the control device to the plurality of slave comprises:
transmitting a common control signal to the control terminals of the slave devices on a group basis in accordance with the data signal from the master control device, wherein
the common control signal controls whether each slave device of a group is operable to receive data signals from the master control device.

20. The method for controlling the high frequency apparatus according to claim 19, the plurality of slave devices forming at least two groups, wherein
each slave device in a group of the at least two groups has a unique address, and
at least two slave devices in different groups share a common address.
